(19) United States
(12) Patent Application Publication
(10) Pub. No.: US 2003/0035154 A1
(43) Pub. Date: Feb. 20, 2003

(54) Document-loading panel structure for scanner

(75) Inventors: Yu-Sam Chang, Taichung City (TW); Hsiu-O Hsu, Hsinchu (TW); Jen-Shou Tseng, Miao-Li Hsien (TW)

Correspondence Address: OSTROLENK FABER GERB & SOFFEN, 1180 AVENUE OF THE AMERICAS, NEW YORK, NY, 100368403

(73) Assignee: Umax Data Systems Inc.

(21) Appl. No.: 09/929,331

(22) Filed: Aug. 14, 2001

(51) Int. Cl. H04N 1/04

(52) U.S. Cl. 358/498

(57) ABSTRACT

A document-loading panel structure for scanner is characterized that a document-loading panel of scanner and an up housing are made of a transparent acrylic material or the like by integral molding; and a chart is either printed or attached on the up housing, a document cover, and/or the document-loading panel.

### FIELD OF THE INVENTION

This invention relates to a document-loading panel structure for scanner, particularly to an acrylic document-loading panel structure for scanner.

### BACKGROUND OF THE INVENTION

The document-loading panel structure of a conventional scanner 10 shown in FIG. 1 is usually made of glass, and when assembling, tape 105 is applied on a glass plate 103 for anchoring the latter on an up housing 109. In use of the scanner, a chart 107 is requested to lie on the glass plate 103 firstly before operating that requires carefulness because of the fragility of glass.

In general, the conventional scanner 10 is made up of a document cover 101, the glass plate 103, the tape 105, the chart 107, and the up housing 109 by assembling instead of integral molding to cost more inevitably.

### SUMMARY OF THE INVENTION

The primary object of this invention is to provide a transparent acrylic plate to serve as a document-loading panel for scanner in substitution for the existing fragile glass plate.

Another object of this invention is to provide an up housing and a document-loading panel for scanner by integral molding of a transparent acrylic material or the like.

In order to realize abovesaid objects, this invention provides a document-loading panel structure for scanner made of a transparent acrylic material, wherein both an up housing and a document-loading panel of a scanner are made of a transparent acrylic material by integral molding; and a chart is printed or attached on the document-loading panel as well as a document cover.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention to be made later are described briefly as follows, in which:

FIG. 1 is a structural view of a conventional scanner;

FIG. 2 shows an embodiment of acrylic document-loading panel structure of this invention for scanner;

FIG. 3 shows an embodiment of an up housing and document-loading panel integrally molded with a transparent acrylic material or the like;

FIG. 4A is a schematic view showing that a chart is provided to the document-loading panel shown in FIG. 3; and

FIG. 4B is a schematic view showing that a document cover with chart is combined to the scanner shown in FIG. 3.

### DETAILED DESCRIPTION OF THE INVENTION

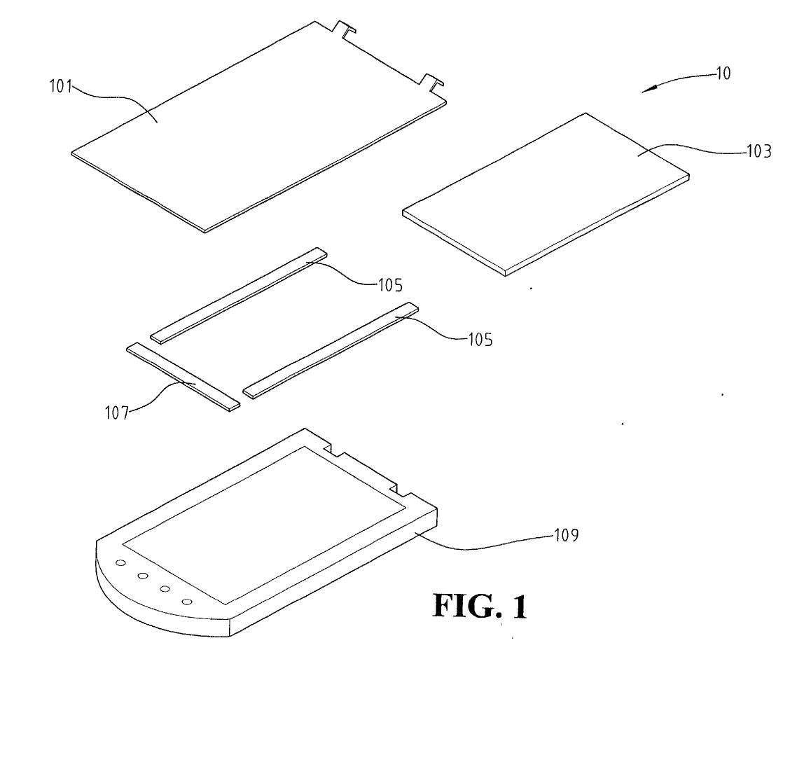

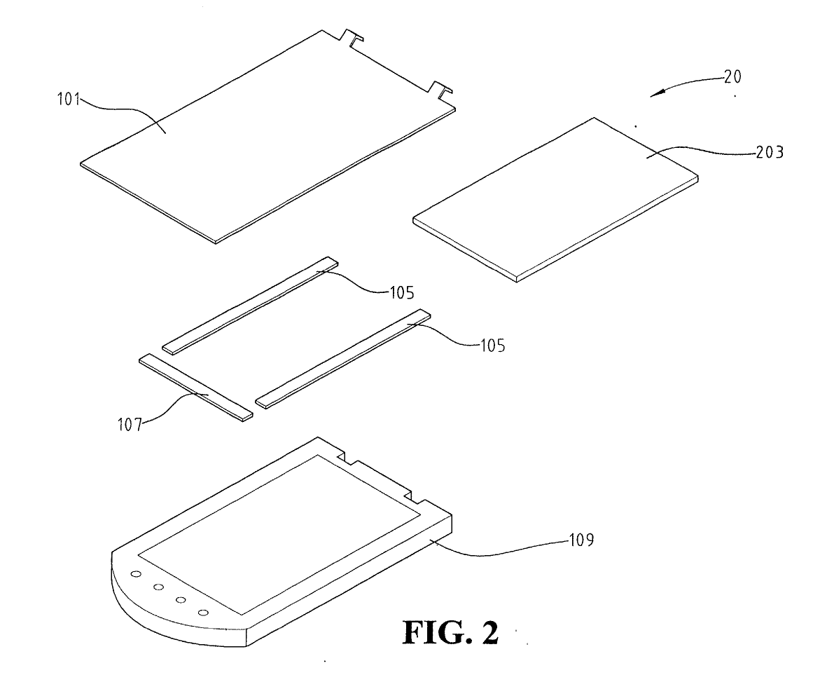

FIG. 2 shows an embodiment of acrylic document-loading panel structure of this invention for scanner. A scanner 20 shown in FIG. 2 is provided with a transparent acrylic document-loading panel 203 in substitution for the glass-made panel 103 shown in FIG. 1 so as to dissolve the problem of fragility. Also in FIG. 2, a chart 107 is attached or printed on the acrylic panel 203 or on a document cover 101.

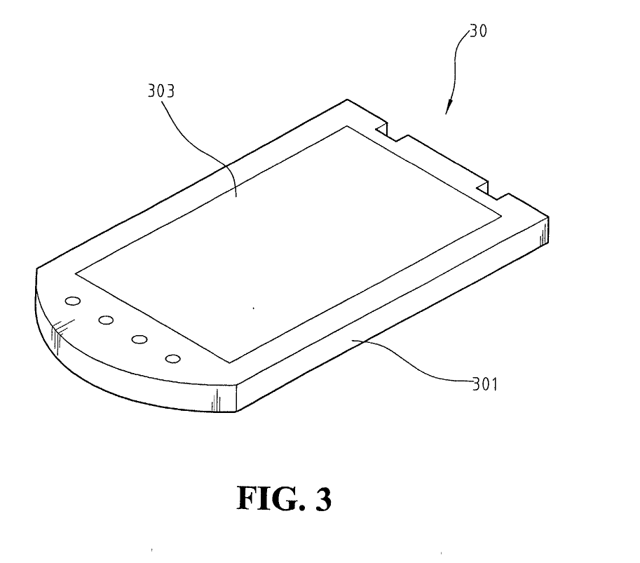

FIG. 3 shows an embodiment of an up housing and document-loading panel integrally molded with a transparent acrylic material or the like. In this figure, a scanner 30 is provided with an up housing 301 and a document-loading panel 303, which are integrally molded with a transparent acrylic material or the like, to substitute for the up housing 109 and the glass document-loading panel 103 shown in FIG. 1.

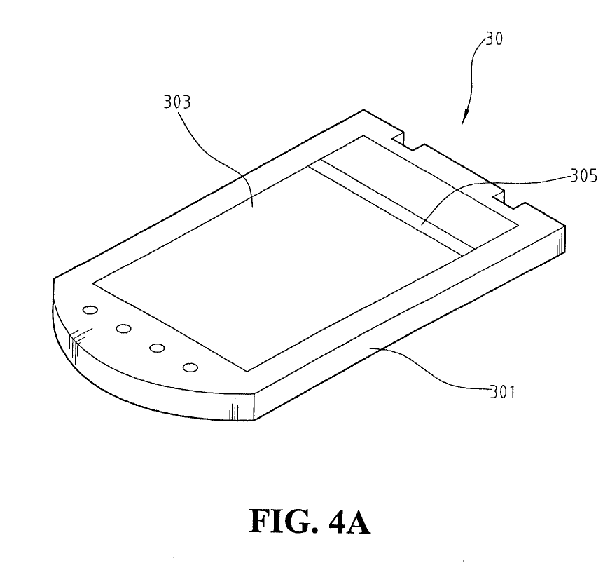

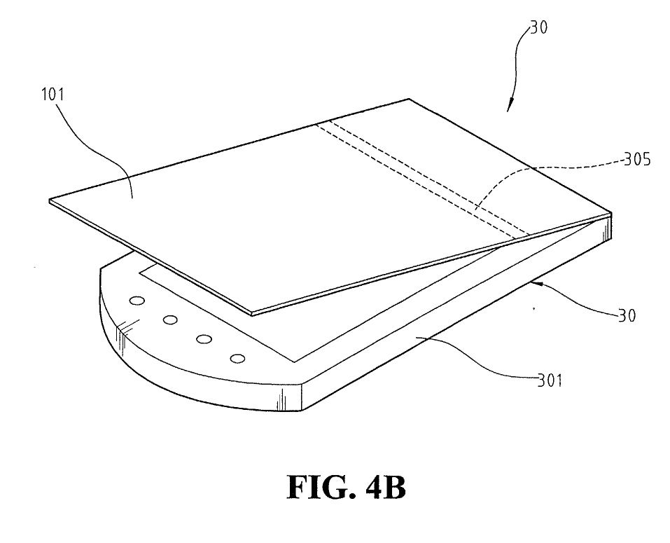

FIG. 4A is a schematic view showing that a chart is provided to the document-loading panel shown in FIG. 3, wherein a chart 305 is attached or printed on the document-loading panel 303 at a proper place.

FIG. 4B is a schematic view showing that a document cover with chart is combined to the scanner shown in FIG. 3. A document cover 101 having the chart 305 attached or printed thereon is combined with the scanner 30.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A document-loading panel structure for scanner, wherein a document-loading panel is made of a transparent acrylic material to become a transparent acrylic document-loading panel.

2. The document-loading panel structure for scanner according to claim 1, wherein a chart is printed on the transparent acrylic document-loading panel directly.

3. The document-loading panel structure for scanner according to claim 1, wherein a chart is attached on the transparent acrylic document-loading panel.

4. The document-loading panel structure for scanner according to claim 1, wherein a chart is printed on a document cover of scanner directly.

5. The document-loading panel structure for scanner according to claim 1, wherein a chart is attached on a document cover of scanner.

6. A document-loading panel structure for scanner, wherein an up housing and a document-loading panel of scanner are made of a transparent acrylic material by integral molding.

7. The document-loading panel structure according to claim 6, wherein a chart is printed on the document-loading panel directly.

8. The document-loading panel structure according to claim 6, wherein a chart is attached on the document-loading panel.

9. The document-loading panel structure according to claim 6, wherein a chart is printed on a document cover of scanner directly.

10. The document-loading panel structure according to claim 6, wherein a chart is attached on a document cover of scanner.

11. A document-loading panel structure for scanner, wherein an up housing and a document-loading panel of scanner are made of a transparent material.

12. The document-loading panel structure according to claim 11, wherein a chart is printed on the document-loading panel directly.

13. The document-loading panel structure according to claim 11, wherein a chart is attached on the document-loading panel.

14. The document-loading panel structure according to claim 11, wherein a chart is printed on a document cover of scanner directly.

15. The document-loading panel structure according to claim 11, wherein a chart is attached on a document cover of scanner.
